(19) United States
(12) Patent Application Publication
(10) Pub. No.: US 2019/0120756 A1
(43) Pub. Date: Apr. 25, 2019

(54) TERAHERTZ REFLECTION IMAGING SYSTEM USING ROTATING POLYHEDRAL MIRROR AND TELECENTRIC F-THETA LENS

(71) Applicant: Electronics and Telecommunications Research Institute, Daejeon (KR)

(72) Inventors: Kiwon MOON, Daejeon (KR); Kyung Hyun PARK, Daejeon (KR); Eui Su LEE, Daejeon (KR); Il Min LEE, Daejeon (KR)

(73) Assignee: Electronics and Telecommunications Research Institute, Daejeon (KR)

(21) Appl. No.: 16/144,504

(22) Filed: Sep. 27, 2018

(30) Foreign Application Priority Data
Oct. 25, 2017 (KR) 10-2017-0139296

(51) Int. Cl. G01N 21/3581; G01J 3/42; G01N 21/47

(52) U.S. Cl. CPC G01N 21/3581; G01J 3/42; G01J 2003/425; G01J 2003/421; G01N 21/4795

(57) ABSTRACT

Disclosed is a terahertz, reflection imaging system using a rotating polyhedral mirror and a telecentric f-theta lens. The terahertz reflection imaging system may include a light source configured to output a terahertz, beam, a rotating polyhedral mirror of which a mirror is combined with each of polyhedral faces, and configured to reflect the terahertz beam transmitted from the light source in a direction in which a specimen is disposed, a telecentric f-theta lens configured to transmit the terahertz beam reflected from the rotating polyhedral mirror to the specimen and correct a chief ray of the terahertz beam reflected from the rotating polyhedral mirror to be parallel to an optical axis of the telecentric f-theta lens, and a detector configured to detect a terahertz beam reflected from the specimen.

### CROSS-REFERENCE TO RELATED APPLICATION(S)

This application claims the priority benefit of Korean Patent Application No. 10-2017-0139296 filed on Oct. 25, 2017, in the Korean Intellectual Property Office, the disclosure of which is incorporated herein by reference for all purposes.

### BACKGROUND

### 1. Field

One or more example embodiments relate to a high-definition and high-speed terahertz imaging system.

### 2. Description of Related Art

Recently, a real-time imaging system using a characteristic of a terahertz beam which is harmless to humans and transmits or penetrates a nonconductive material, such as, for example, plastic, ceramics, and vinyl is being developed. Such a terahertz imaging system is used in a wide range of fields, such as, nondestructive inspection of various plastic and ceramic structures, food inspection, and the like.

The terahertz imaging system may be provided in numerous types based on a light source, a detector, and an optical system, and the like that are used in the terahertz imaging system.

Among existing terahertz imaging systems, there is a raster scanning-based terahertz imaging system configured to dispose a specimen at a position into which a terahertz beam is condensed from a terahertz generator, measure a terahertz beam transmitted or reflected from the specimen using an optical system, perform raster-scanning on the specimen, and then obtain an image from the raster-scanning. In addition, there is also a one-dimensional (1D) array-based terahertz imaging system using a 1D array detector to detect, in a row, a terahertz beam transmitted or reflected from a specimen. In addition, there is also a two-dimensional (2D) array-based terahertz imaging system using a 2D array detector to detect, in a plane, a terahertz beam transmitted or reflected from a specimen.

Among the existing terahertz imaging systems, the 1D array-based terahertz imaging system or the 2D array-based terahertz imaging system may be fast in imaging processing. However, the 1D array-based terahertz imaging system and the 2D array-based terahertz imaging system may need a high-power light source.

In addition, for high-definition imaging, a terahertz imaging system may need to have a high numerical aperture of a lens or a reflector used to condense a terahertz beam into a specimen or a terahertz detector. Herein, a definition d may be represented by the following equation.

d/2=1.22λN,

where d denotes definition or resolution, and λ denotes a wavelength. N denotes a f-number of a lens, for example, N=f (focal length)/D (diameter of lens aperture). For example, to obtain a resolution of 1 millimeter (mm) at 100 gigahertz (GHz) frequency, approximately 0.14 of f-number of a lens may be needed because a wavelength is 3 mm.

That is, since a diameter of an aperture of a lens needs to be at least seven times a focal length, for example, 3 centimeters (cm), a diameter of a collimated terahertz beam to be incident on the lens may need to be 21 cm. In addition, based on the collimated terahertz beam with the diameter of 21 cm, a terahertz imaging system may need to be produced to be larger in size.

Thus, there is a desire for a terahertz imaging system that may obtain a high-definition image, by increasing a diameter of a collimated terahertz beam without increasing a size of the terahertz imaging system.

### SUMMARY

An aspect provides a terahertz reflection imaging system that is reduced in size and modularized into a small size and is configured to facilitate optical alignment by allowing a terahertz beam to be transmitted in parallel to a rotation axis using a rotating polyhedral mirror, which is a rotating mirror in a polygonal shape.

Another aspect also provides a terahertz, reflection imaging system that is reduced in size, yet obtains a high-definition image, compared to an existing terahertz imaging system, by reflecting a terahertz beam using a rotating parabolic mirror smaller than a mirror used in the existing terahertz imaging system.

According to an aspect, there is provided a terahertz, reflection imaging system including a light source configured to output a terahertz beam, a rotating polyhedral mirror of which a mirror is combined with each of polyhedral faces, and configured to reflect a terahertz beam transmitted from the light source in a direction in which a specimen is disposed, a telecentric f-theta lens configured to transmit the terahertz beam reflected from the rotating polyhedral mirror to the specimen and correct a chief ray of the terahertz beam reflected from the rotating polyhedral mirror to be parallel to an optical axis of the telecentric f-theta lens, and a detector configured to detect a terahertz beam reflected from the specimen. The rotating polyhedral mirror may rotate in a preset direction to change a reflection direction of the terahertz beam and change a position of the terahertz beam incident on the specimen.

The rotating polyhedral mirror may include a first face configured to reflect the terahertz, beam in the direction in which the specimen is disposed, and a second face configured to reflect a terahertz beam reflected from the specimen and passing through the telecentric f-theta lens in a direction in which the detector is disposed. The telecentric f-theta lens may transmit the terahertz beam reflected from the specimen to the second face.

When the light source does not output a collimated terahertz beam, the terahertz reflection imaging system may further include a collimating lens or multiple number of lenses configured to collimate the terahertz beam output from the light source and transmit the collimated terahertz beam to the rotating polyhedral mirror, and a condensing lens configured to condense the terahertz beam reflected from the specimen and transmit the condensed terahertz beam to the detector.

The terahertz reflection imaging system may further include a beam splitter configured to allow the terahertz beam output from the light source to be transmitted and reflect the terahertz beam reflected from the rotating polyhedral mirror in the direction in which the detector is disposed. The telecentric f-theta lens may transmit the terahertz beam reflected from the specimen to the rotating polyhedral mirror, and the rotating polyhedral mirror may reflect the terahertz beam transmitted from the telecentric f-theta lens in a direction in which the beam splitter is disposed.

According to another aspect, there is provided a terahertz reflection imaging system including a light source configured to output a terahertz beam, a rotating mirror configured to reflect a terahertz beam transmitted from the light source in a direction in which a specimen is disposed using a mirror tilted at a preset angle, a telecentric f-theta lens configured to transmit the terahertz beam reflected from the rotating mirror to the specimen and correct a chief ray of the terahertz beam reflected from the rotating mirror to be parallel to an optimal axis of the telecentric f-theta lens, and a detector configured to detect a terahertz beam reflected from the specimen. The rotating mirror may be configured such that the mirror having a rotation axis rotates in a preset direction to change a reflection direction of the terahertz, beam and change a position of the terahertz beam incident on the specimen.

When the light source does not output a collimated terahertz beam, the terahertz reflection imaging system may further include a collimating lens or multiple number of lenses configured to collimate the terahertz beam output from the light source and transmit the collimated terahertz beam to the rotating mirror, and a condensing lens configured to condense the terahertz beam reflected from the specimen and transmit the condensed terahertz beam to the detector.

According to still another aspect, there is provided a terahertz reflection imaging system including a light source configured to output a terahertz beam, a rotating parabolic mirror configured to reflect a terahertz beam transmitted from the light source in a direction in which a specimen is disposed using a parabolic mirror, a telecentric f-theta lens configured to transmit the terahertz beam reflected from the rotating parabolic mirror to the specimen and correct a chief ray of the terahertz beam reflected from the rotating parabolic mirror to be parallel to an optical axis of the telecentric f-theta lens, and a detector configured to detect a terahertz beam reflected from the specimen. The parabolic mirror may collimate the terahertz beam transmitted from the light source and reflect the collimated terahertz beam to the telecentric f-theta lens. The rotating parabolic mirror may be configured such that the parabolic mirror having a rotation axis rotates in a preset direction to change a reflection direction of the terahertz beam and change a position of the terahertz beam incident on the specimen.

According to yet another aspect, there is provided a terahertz reflection imaging system including a light source configured to output a terahertz beam, a rotating parabolic mirror configured to reflect a terahertz beam transmitted from the light source in a direction in which a cylindrical specimen is disposed using a parabolic mirror combined with a rotation axis, and a detector configured to detect a terahertz beam reflected from the cylindrical specimen. The parabolic mirror may reflect the terahertz beam transmitted from the light source to be transmitted vertically to an inner side of the cylindrical specimen. The rotating parabolic mirror may be configured such that the parabolic mirror having the rotation axis rotates in a preset direction to change a position of the terahertz beam incident on the cylindrical specimen.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a configuration of a terahertz, reflection imaging system according to an example embodiment;

FIG. 2 is a diagram illustrating an example of a terahertz reflection imaging system according to an example embodiment;

FIG. 3 is a diagram illustrating an example of a change in position of a terahertz, beam to be incident on a specimen of a terahertz reflection imaging system according to an example embodiment;

FIG. 4 is a diagram illustrating an example of vertical scanning performed by a terahertz reflection imaging system according to an example embodiment:

FIG. 5 is a diagram illustrating another example of a terahertz reflection imaging system according to an example embodiment;

FIG. 6 is a diagram illustrating still another example of a terahertz reflection imaging system according to an example embodiment;

FIG. 7 is a diagram illustrating yet another example of a terahertz reflection imaging system according to an example embodiment; and

FIG. 8 is a diagram illustrating further another example of a terahertz reflection imaging system according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

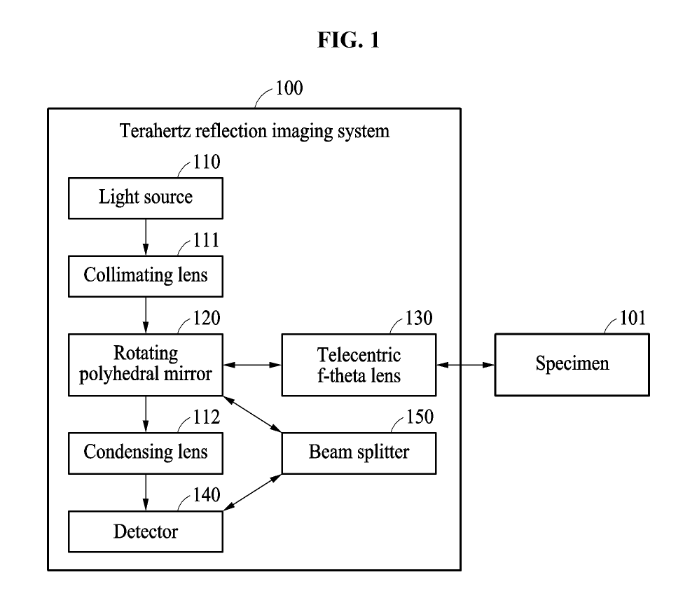

FIG. 1 is a diagram illustrating an example of a configuration of a terahertz reflection imaging system according to an example embodiment.

Referring to FIG. 1, a terahertz reflection imaging system 100 includes at least one of a light source 110, a collimating lens or multiple number of lenses 111, a rotating polyhedral mirror 120, a telecentric f-theta lens 130, a condensing lens 112, a detector 140, or a beam splitter 150.

The light source 110 outputs a terahertz beam in a direction in which the rotating polyhedral mirror 120 is disposed.

For example, the light source 110 may be one of a terahertz photoconductive antenna, a terahertz photomixer, a Gunn diode, and an impact ionization avalanche transit-time (IMPATT) diode.

The terahertz photoconductive antenna may switch conductivity of a semiconductor material at an ultrahigh speed using a femtosecond laser and generate an ultrahigh-speed transient current to output a broadband (e.g., 0.2-3 THz) terahertz beam.

The terahertz photomixer may generate a terahertz beam in a form of continuous waves using an inexpensive semiconductor laser. The terahertz photomixer may superimpose laser beams generated from a frequency-tunable distributed feedback laser diode (DFB-LD) to generate an optical beating corresponding to a frequency difference between the laser beams. The terahertz photomixer may allow this to be input to or incident on a photomixer element and generate an electromagnetic wave corresponding to a beating frequency, and then generate a terahertz electromagnetic wave by adjusting each DFB-LD frequency.

The Gunn diode is a two-terminal device having a region of a current-voltage characteristic curve, or an I-V curve, that shows a negative resistance, and may use this negative resistance region to increase an eigenfrequency determined by a resistor-capacitor (RC) time constant and generate a high-frequency electromagnetic wave.

The IMPATT diode is a two-terminal device having a region of an I-V curve that shows a negative resistance and may perform similar functions to those of the Gunn diode.

The terahertz beam output from the light source 110 may be a collimated terahertz beam or a noncollimated terahertz beam.

In a case in which the light source 110 does not output a collimated terahertz beam, the collimating lens or multiple number of lenses 111 may be used to collimate the terahertz beam output from the light source 110 and transmit the collimated terahertz beam to the rotating polyhedral mirror 120. In addition, the condensing lens 112 may be used to condense a terahertz beam reflected from a specimen 101 and transmit the condensed terahertz beam to the detector 140. The collimating lens or multiple number of lenses 111 and the condensing lens 112 may be replaced with an off-axis parabolic mirror.

That is, when the light source 110 outputs a noncollimated terahertz beam, the terahertz reflection imaging system 100 may further include the collimating lens or multiple number of lenses 111 to transmit a collimated terahertz beam to the specimen 101. Herein, when the light source 110 outputs the noncollimated terahertz beam, the detector 140 may detect only the noncollimated terahertz beam because the detector 140 is a component corresponding to the light source 110. Thus, when the terahertz, reflection imaging system 100 includes the collimating lens or multiple number of lenses 111, the terahertz reflection imaging system 100 may further include the condensing lens 112 to condense a terahertz beam collimated by the collimating lens or multiple number of lenses 111.

In addition, in a case in which the detector 140 detects a collimated terahertz beam although the light source 110 outputs a noncollimated terahertz beam, the terahertz reflection imaging system 100 may further include the collimating lens or multiple number of lenses 111 without the condensing lens 112.

A diameter of a collimated terahertz beam may be greater than or equal to a threshold value to achieve a high definition or resolution. For example, a diameter of a collimated terahertz beam may be greater than or equal to 5 centimeters (cm). In addition, an area of a reflective surface of the rotating polyhedral mirror 120 that reflects a terahertz beam may be at least twice a cross-sectional area of the collimated terahertz beam.

The rotating polyhedral mirror 120 of which a mirror is combined with each of polyhedral faces reflects the terahertz beam transmitted from the light source 110 in a direction in which the specimen 101 is disposed.

For example, the rotating polyhedral mirror 120 may include a first face configured to reflect the terahertz beam in the direction in which the specimen 101 is disposed, and a second face configured to reflect a terahertz beam that is reflected from the specimen 101 and passes through the telecentric f-theta lens 130 in a direction in which the detector 140 is disposed.

In addition, the rotating polyhedral mirror 120 uses one of reflective surfaces with which the mirrors are respectively combined to reflect the terahertz beam in the direction in which the specimen 101 is disposed and reflect the terahertz beam that is reflected from the specimen 101 and passes through the telecentric f-theta lens 130 in the direction in which the detector 140 is disposed.

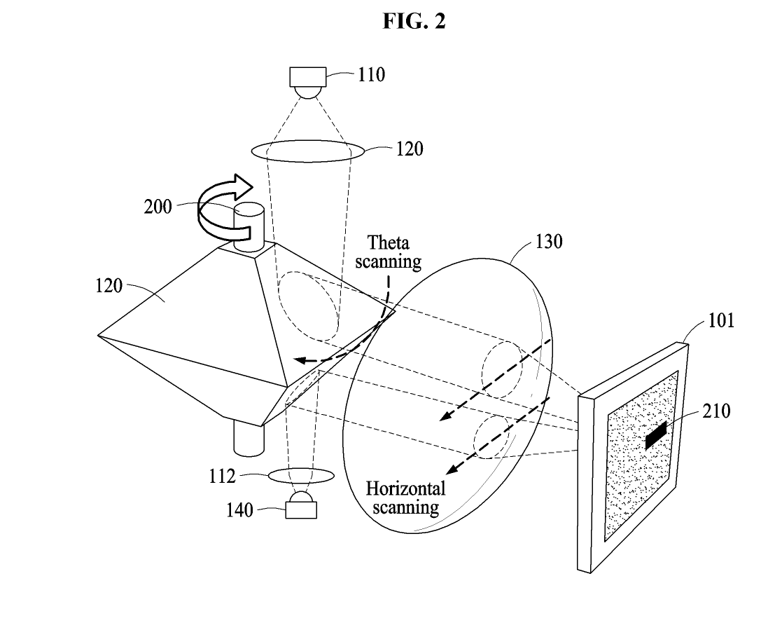

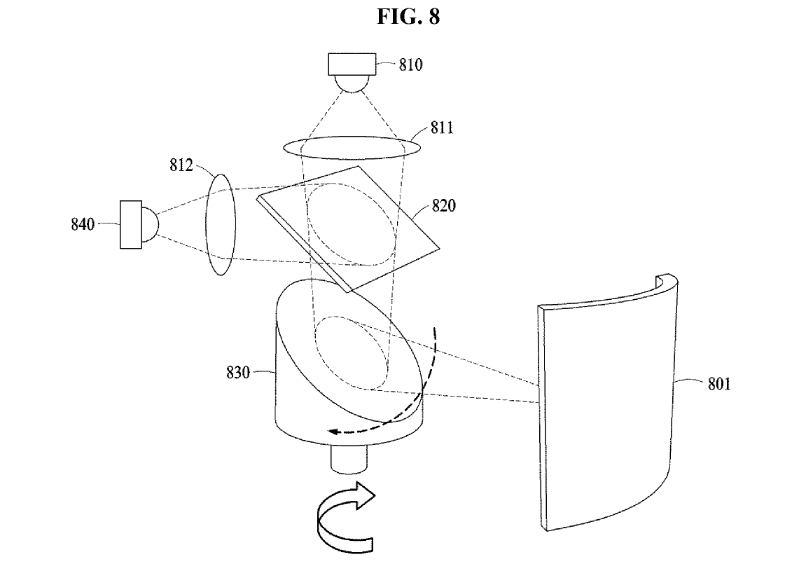

Herein, in addition to example shapes illustrated in FIGS. 2 and 8, the rotating polyhedral mirror 120 may be provided in a shape that may change an incidence angle of a terahertz beam to be transmitted to the telecentric f-theta lens 130 based on a rotation thereof.

The rotating polyhedral mirror 120 may be replaced with a rotating mirror configured to reflect a terahertz beam transmitted from the light source 110 in the direction in which the specimen 101 is disposed using a mirror tilted at a predetermined angle, or with a rotating parabolic mirror configured to reflect a terahertz beam transmitted from the light source 110 in the direction in which the specimen 101 is disposed using a parabolic mirror having a rotation axis.

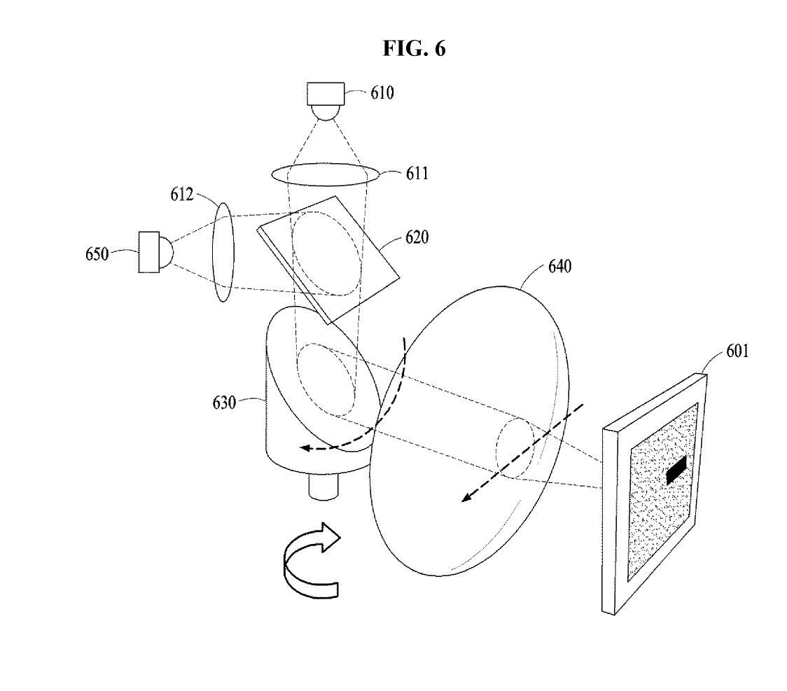

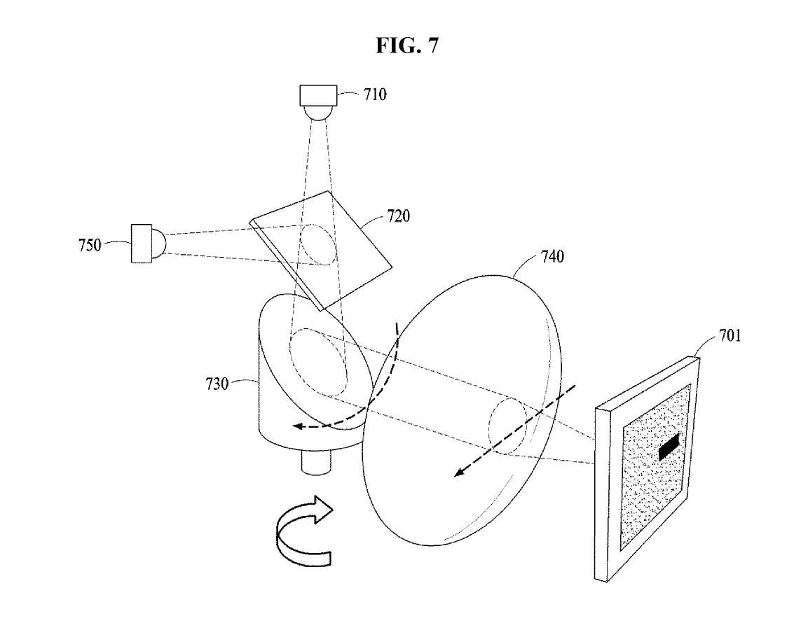

A structure of the terahertz reflection imaging system 100 in which the rotating polyhedral mirror 120 is replaced with the rotating mirror will be described in detail with reference to FIG. 6, and a structure of the terahertz, reflection imaging system 100 in which the rotating polyhedral mirror 120 is replaced with the rotating parabolic mirror will be described in detail with reference to FIGS. 7 and 8.

The telecentric f-theta lens 130 is disposed on a path along which the terahertz beam reflected from the rotating polyhedral mirror 120 is transmitted to the specimen 101 such that the terahertz beam reflected from the rotating polyhedral mirror 120 is transmitted to the specimen 101. Herein, the telecentric f-theta lens 130 corrects a chief ray of the terahertz beam reflected from the rotating polyhedral mirror 120 to be parallel to an optical axis of the telecentric f-theta lens 130. For example, the telecentric f-theta lens 130 may be a telecentric f-theta lens.

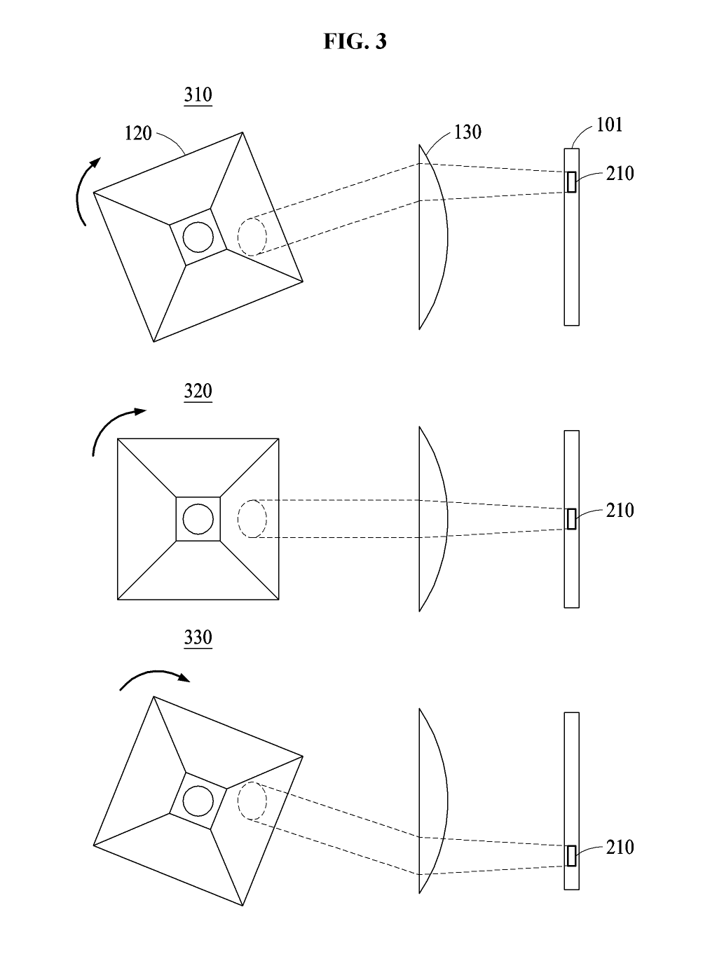

Hereinafter, how a terahertz beam reflected from the rotating polyhedral mirror 120 is transmitted to, or incident on, the specimen 101 will be described in detail with reference to FIG. 3.

In addition, in a case in which the specimen 101 is in a cylindrical form, a position of a terahertz beam to be transmitted to, or incident onto, the specimen 101 may be changed based on an incidence angle of the terahertz beam reflected from the rotating polyhedral mirror 120, although the telecentric f-theta lens 130 is absent. Thus, the terahertz reflection imaging system 100 that may scan an inner side of the cylindrical specimen 101 may not include the telecentric f-theta lens 130. A structure of the terahertz reflection imaging system 100 in which the telecentric f-theta lens 130 is not included will be described in detail with reference to FIG. 8.

The detector 140 detects a terahertz beam reflected from the specimen 101. Herein, the terahertz beam reflected from the specimen 101 may pass through the telecentric f-theta lens 130 and the rotating polyhedral mirror 120 to be transmitted to the detector 140.

The terahertz reflection imaging system 100 may scan the specimen 101 using a terahertz beam detected by the detector 140.

For example, in a case in which the light source 110 is the terahertz photoconductive antenna, the detector 140 may also be a photoconductive antenna for terahertz detection. In this example, the photoconductive antenna for terahertz detection may require a femtosecond laser and a mechanical delay line.

For another example, in a case in which the light source 110 is the terahertz photomixer, the detector 140 may be the same terahertz photomixer as the light source 110. In this example, the detector 140 may allow a same beating light source as the one used for the light source 110 to generate a terahertz beam, to be transmitted to an absorption portion of the terahertz photomixer.

For still another example, when measuring only an intensity of a terahertz beam reflected from the specimen 101 without measuring a size and a phase of the terahertz beam reflected from the specimen 101, the detector 140 may use a device such as, for example, a Schottky-barrier diode (SBD). In this example, the SBD may measure an electric field strength of the terahertz beam using a rectifying characteristic of a diode.

In a case in which the rotating polyhedral mirror 120 reflects a terahertz beam in the direction in which the specimen 101 is disposed and reflects a terahertz, beam reflected from the specimen 101 and passing through the telecentric f-theta lens 130 in the direction in which the detector 140 is disposed, using one of the reflective surfaces with which the respective mirrors are combined, a path along which a terahertz beam is transmitted from the light source 110 to the rotating polyhedral mirror 120 and a path along which a terahertz beam is reflected from the rotating polyhedral mirror 120 to the detector 140 may overlap each other.

In such a case, the terahertz reflection imaging system 100 may thus further include the beam splitter 150 to split the path along which the terahertz beam is transmitted from the light source 110 to the rotating polyhedral mirror 120 and the path along which the terahertz beam is reflected from the rotating polyhedral mirror 120 to the detector 140. Herein, the beam splitter 150 may allow the terahertz beam transmitted from the light source 110 to the rotating polyhedral mirror 120 to be transmitted, and allow the terahertz beam reflected from the rotating polyhedral mirror 120 to the detector 140 to be reflected in the direction in which the detector 140 is disposed, thereby splitting the path of the terahertz beam to be transmitted from the light source 110 to the rotating polyhedral mirror 120 and the path of the terahertz beam to be reflected from the rotating polyhedral mirror 120 to the detector 140.

That is, the terahertz reflection imaging system 100 may omit the collimating lens or multiple number of lenses 111, the telecentric f-theta lens 130, and the condensing lens 112 based on a type of the light source 110 and a type of the specimen 101 and may also add the beam splitter 150 based on a type of the rotating polyhedral mirror 120.

According to an example embodiment, the terahertz reflection imaging system 100 may allow a terahertz beam to be transmitted in parallel to a rotation axis using a rotating polyhedral mirror which is a rotating mirror of a polyhedral shape, and may thus be reduced in size and modularized into a small size while facilitating optical alignment.

In addition, the terahertz reflection imaging system 100 may also use a rotating parabolic mirror which is smaller in size than a mirror used for an existing terahertz imaging system to reflect a terahertz beam, and may thus obtain a higher-definition image with the smaller size compared to the existing terahertz imaging system.

FIG. 2 is a diagram illustrating an example of a terahertz reflection imaging system according to an example embodiment.

Referring to FIG. 2, in a terahertz reflection imaging system, a light source 110 and a detector 140 are disposed in a direction parallel to a rotation axis 200 of a rotating polyhedral mirror 120. In addition, a specimen 101 to be scanned is disposed in a direction perpendicular to the rotation axis 200 of the rotating polyhedral mirror 120 or a direction at an angle close to a perpendicular angle. In addition, a telecentric f-theta lens 130 is disposed between the rotating polyhedral mirror 120 and the specimen 101.

A first face of the rotating polyhedral mirror 120 is a reflective surface of which a mirror is combined with a face positioned on an upper portion of the rotating polyhedral mirror 120, and a second face of the rotating polyhedral mirror 120 is a reflective surface of which a mirror is combined with a face positioned on a lower portion of the rotating polyhedral mirror 120. The rotating polyhedral mirror 120 is illustrated as having four first faces and four second faces in the example of FIG. 2. However, a number and a shape of first faces and second faces may vary according to examples.

When the light source 110 outputs a terahertz beam having a diverging characteristic, a collimating lens or multiple number of lenses 111 collimates the terahertz beam output from the light source 110 and transmits the collimated terahertz beam to the first face of the rotating polyhedral mirror 120. Herein, a diameter of the terahertz beam collimated by the collimating lens or multiple number of lenses 111 may be larger than that of the terahertz, beam output form the light source 110.

The first face of the rotating polyhedral mirror 120 reflects the terahertz beam collimated by the collimating lens or multiple number of lenses 111 in a direction perpendicular to the rotation axis 200. Herein, the terahertz beam reflected from the first face of the rotating polyhedral mirror 120 may be transmitted to the telecentric f-theta lens 130.

When an incidence angle of a terahertz beam to be transmitted to the telecentric f-theta lens 130 is changed by a rotation of the rotating polyhedral mirror 120, a position of a terahertz beam that passes through the telecentric f-theta lens 130 and is then transmitted to the specimen 101 may be changed. In detail, a position of a terahertz beam 210 incident on the specimen 101 is changed in a horizontal direction by a rotation of the rotating polyhedral mirror 120, and the specimen 101 may be scanned in the horizontal direction.

After the terahertz beam 210 incident on the specimen 101 is reflected from the specimen 101, the terahertz beam 210 is transmitted to the second face of the rotating polyhedral mirror 120 through the telecentric f-theta lens 130.

That is, according to the example illustrated in FIG. 2, the telecentric f-theta lens 130 may be designed such that a terahertz beam reflected from the first face of the rotating polyhedral mirror 120 is to be transmitted vertically to the specimen 101 and a terahertz beam reflected from the specimen 101 is to be transmitted to the second face of the rotating polyhedral mirror 120.

Herein, the second face of the rotating polyhedral mirror 120 reflects a terahertz beam passing through the telecentric f-theta lens 130 in a direction parallel to the rotation axis 200.

The terahertz beam reflected from the second face of the rotating polyhedral mirror 120 is then condensed into the detector 140 while passing through a condensing lens 112.

FIG. 3 is a diagram illustrating an example of a change in position of a terahertz, beam incident on a specimen of a terahertz reflection imaging system according to an example embodiment.

Referring to FIG. 3, in operation 310, a terahertz beam incident on a rotating polyhedral mirror 120 is reflected from a mirror combined with the rotating polyhedral mirror 120 to a left side of a telecentric f-theta lens 130. The telecentric f-theta lens 130 corrects a chief ray of the terahertz beam reflected from the rotating polyhedral mirror 120 to be parallel to an optical axis of the telecentric f-theta lens 130 to refract the terahertz beam reflected from the rotating polyhedral mirror 120 to be transmitted vertically to a specimen 101.

In operation 320, the terahertz beam incident on the rotating polyhedral mirror 120 is reflected from the mirror combined with the rotating polyhedral mirror 120 to a center of the telecentric f-theta lens 130. The telecentric f-theta lens 130 allows the terahertz beam reflected from the rotating polyhedral mirror 120 to be transmitted vertically to the specimen 101.

In operation 330, the terahertz beam incident on the rotating polyhedral mirror 120 is reflected from the mirror combined with the rotating polyhedral mirror 120 to a right side of the telecentric f-theta lens 130. The telecentric f-theta lens 130 corrects a chief ray of the terahertz beam reflected from the rotating polyhedral mirror 120 to refract the terahertz beam reflected from the rotating polyhedral mirror 120 to be transmitted vertically to the specimen 101.

That is, while the rotating polyhedral mirror 120 is rotating on a rotation axis, a direction of the mirror combined with the rotating polyhedral mirror 120 may be changed and a position of the terahertz beam reflected from the rotating polyhedral mirror 120 to be transmitted to the telecentric f-theta lens 130 may also be changed accordingly. As illustrated in FIG. 3, the telecentric f-theta lens 130 refracts the terahertz beam reflected from the rotating polyhedral mirror 120 to be transmitted vertically to the specimen 101, and thus a position of a terahertz beam 210 incident on the specimen 101 is changed from a left side to a right side of the specimen 101.

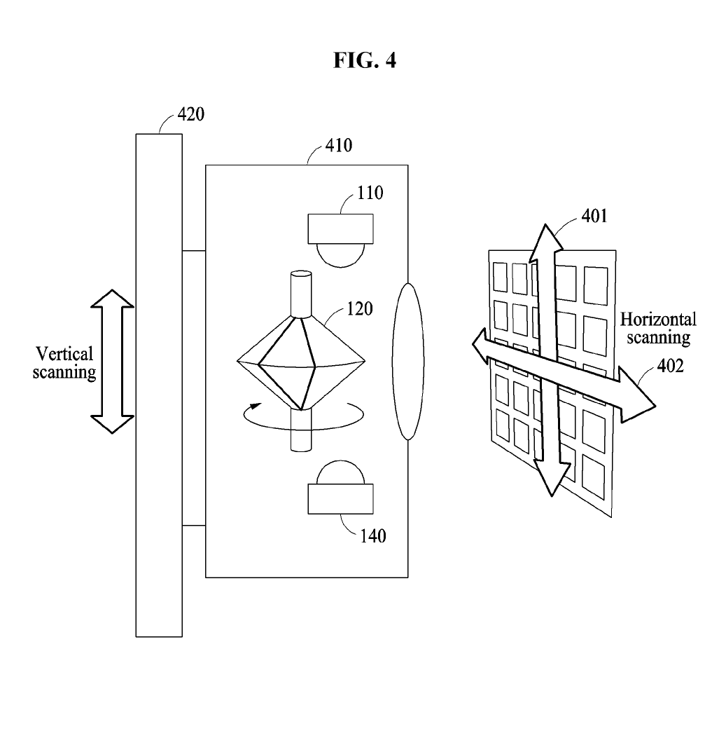

FIG. 4 is a diagram illustrating an example of vertical scanning performed by a terahertz reflection imaging system according to an example embodiment.

Referring to FIG. 4, a terahertz reflection imaging system 100 includes a horizontal scan module 410 and a vertical movement stage 420. The horizontal scan module 410 includes at least one of the collimating lens or multiple number of lenses 111, the rotating polyhedral mirror 120, the telecentric f-theta lens 130, the condensing lens 112, the detector 140, or the beam splitter 150, which is illustrated in FIG. 1, to perform horizontal scanning 402 on a specimen 101. A detailed structure of the horizontal scan module 410 may be the same as one of examples illustrated in FIGS. 2, and 5 through 8.

When the horizontal scanning 402 on the specimen 101 is completed by the horizontal scan module 410, the vertical movement stage 420 may move the horizontal scan module 410 vertically such that vertical scanning 401 may be performed on an area of the specimen 101 for which scanning is not completed yet.

That is, the terahertz reflection imaging system 100 may move vertically the horizontal scan module 410 configured to scan the specimen 101 in a horizontal direction and may thus obtain a two-dimensional (2D) image of the specimen 101 through scanning.

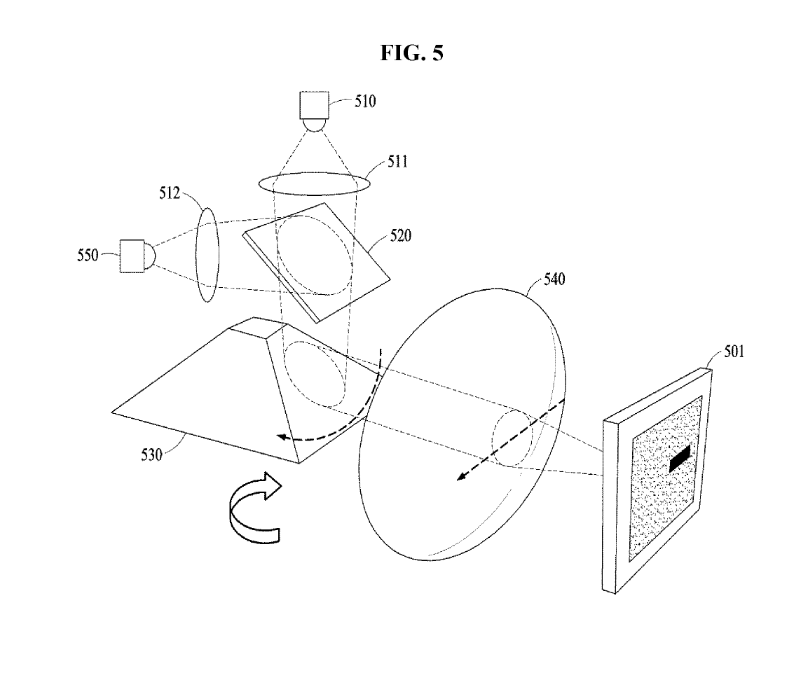

FIG. 5 is a diagram illustrating another example of a terahertz reflection imaging system according to an example embodiment.

FIG. 5 illustrates a terahertz reflection imaging system including a rotating polyhedral mirror 530 of which a mirror is combined with only an upper portion of the rotating polyhedral mirror 530.

Referring to FIG. 5, a light source 510 is disposed in a direction parallel to a rotation axis of the rotating polyhedral mirror 530. In addition, a specimen 501 to be scanned and a detector 550 are disposed in a direction perpendicular to the rotation axis of the rotating polyhedral mirror 530, or a direction at an angle close to a perpendicular angle. In addition, a telecentric f-theta lens 540 is disposed between the rotating polyhedral mirror 120 and the specimen 501.

In the example of FIG. 5, the terahertz reflection imaging system includes a beam splitter 520 configured to allow a terahertz beam output from the light source 510 to be transmitted and a terahertz beam reflected from the rotating polyhedral mirror 530 to be reflected in a direction in which the detector 550 is disposed. The rotating polyhedral mirror 530 is illustrated in FIG. 5 as having reflective surfaces with which four mirrors are combined. However, a number and a shape of reflective surfaces may vary according to examples.

When the light source 510 outputs a terahertz beam having a diverging characteristic, a collimating lens 511 collimates the terahertz beam output from the light source 510 and transmits the collimated terahertz beam to the beam splitter 520.

A terahertz beam transmitted from the beam splitter 520 is reflected from the rotating polyhedral mirror 530 to be transmitted to the telecentric f-theta lens 540. The telecentric f-theta lens 540 corrects a chief ray of the terahertz beam to be parallel to an optical axis of the telecentric f-theta lens 540. Herein, when an incidence angle of the terahertz beam incident on the telecentric f-theta lens 540 is changed by a rotation of the rotating polyhedral mirror 530, a position of a terahertz beam that passes through the telecentric f-theta lens 540 to be transmitted to the specimen 501 may also be changed.

In addition, the terahertz beam incident on the specimen 501 is reflected from the specimen 501, and then passes through the telecentric f-theta lens 540 to be transmitted to the rotating polyhedral mirror 530. Herein, the terahertz beam incident on the rotating polyhedral mirror 530 is reflected in a direction in which the beam splitter 520 is disposed. In addition, the terahertz beam reflected from the rotating polyhedral mirror 530 is reflected from the beam splitter 520 in a direction in which the detector 550 is disposed.

Herein, the terahertz, beam reflected from the beam splitter 520 is condensed into the detector 550 while passing through a condensing lens 512.

In the example of FIG. 5, the terahertz reflection imaging system may include the rotating polyhedral mirror 530 of which only the upper portion is combined with a mirror and may thus be smaller in size compared to the example of the terahertz reflection imaging system illustrated in FIG. 2. In addition, the telecentric f-theta lens 540 may not include a structure used to allow a terahertz beam reflected from the specimen 501 to be transmitted to another path different from that for a terahertz beam reflected from the rotating polyhedral mirror 530 and may thus be more simplified or streamlined in its configuration compared to the telecentric f-theta lens 130 illustrated in FIG. 2.

FIG. 6 is a diagram illustrating still another example of a terahertz reflection imaging system according to an example embodiment.

FIG. 6 illustrates a terahertz reflection imaging system in which the rotating polyhedral mirror 530 of FIG. 5 is replaced with a rotating mirror 630 configured to reflect a terahertz beam transmitted from a light source 610 in a direction in which a specimen 601 is disposed using a mirror tilted at a predetermined angle.

Referring to FIG. 6, when the light source 610 outputs a terahertz beam having a diverging characteristic, a collimating lens 611 collimates the terahertz, beam output from the light source 610 and transmits the collimated terahertz beam to a beam splitter 620.

A terahertz beam transmitted from the beam splitter 620 is reflected from the rotating mirror 630 to be transmitted to a telecentric f-theta lens 640. The telecentric f-theta lens 640 corrects a chief ray of the terahertz beam to be parallel to an optical axis of the telecentric f-theta lens 640. Thus, when an incidence angle of the terahertz beam incident on the telecentric f-theta lens 640 is changed by a rotation of the rotating mirror 630, a position of a terahertz beam that passes through the telecentric f-theta lens 640 to be transmitted to the specimen 601 may also be changed.

In addition, the terahertz beam incident on the specimen 601 is reflected from the specimen 601 and is then to be transmitted to the rotating mirror 630 through the telecentric f-theta lens 640. Herein, the terahertz beam incident on the rotating mirror 630 is reflected from the rotating mirror 630 in a direction in which the beam splitter 620 is disposed. In addition, the terahertz beam reflected from the rotating mirror 630 is reflected from the beam splitter 620 in a direction in which a detector 650 is disposed.

Herein, the terahertz beam reflected from the beam splitter 620 is condensed into the detector 650 while passing through a condensing lens 612.

As illustrated in FIGS. 2 and 5, a rotating polyhedral mirror may reflect a terahertz beam by a mirror between a rotation axis and an outer rim of a rotating monohedral mirror, and thus a diameter of a terahertz beam to be reflected may be smaller than a radius of the rotating polyhedral mirror. However, as illustrated in FIG. 6, the rotating mirror 630 may be combined on a rotation axis and may thus reflect a terahertz beam having a diameter greater than a radius of the rotating mirror 630.

That is, the rotating mirror 630 may reflect a terahertz beam having a greater diameter, compared to a rotating polyhedral mirror of a same size as the rotating mirror 630, and thus the terahertz reflection imaging system including the rotating mirror 630 may have a higher definition compared to a terahertz reflecting imaging system including the rotating polyhedral mirror.

FIG. 7 is a diagram illustrating yet another example of a terahertz reflection imaging system according to an example embodiment.

FIG. 7 illustrates a terahertz reflection imaging system including a rotating parabolic mirror 730 without a collimating lens or multiple number of lenses and a condensing lens. In this example illustrated in FIG. 7, a mirror on a reflective surface of the rotating parabolic mirror 730 may be provided in a parabolic form and configured to collimate a terahertz beam output from a light source 710 and reflect the collimated terahertz beam.

Referring to FIG. 7, a terahertz, beam having a diverging characteristic that is output from the light source 710 is transmitted to the rotating parabolic mirror 730 through a beam splitter 720. The terahertz beam incident on the rotating parabolic mirror 730 is collimated while being reflected from the rotating parabolic mirror 730 and is then transmitted to a telecentric f-theta lens 740. The telecentric f-theta lens 740 corrects a chief ray of the terahertz beam to be parallel to an optical axis of the telecentric f-theta lens 740. Thus, when an incidence angle of the terahertz beam incident on the telecentric f-theta lens 740 is changed by a rotation of the rotating parabolic mirror 730, a position of a terahertz beam that passes through the telecentric f-theta lens 740 to be transmitted to a specimen 701 may also be changed.

In addition, the terahertz beam incident on the specimen 701 is reflected from the specimen 701 and is then transmitted to the rotating parabolic mirror 730 through the telecentric f-theta lens 740. The terahertz beam incident on the rotating parabolic mirror 730 is condensed while being reflected from the rotating parabolic mirror 730 in a direction in which the beam splitter 720 is disposed. In addition, the terahertz beam reflected from the rotating parabolic mirror 730 is reflected from the beam splitter 720 in a direction in which a detector 750 is disposed and is then transmitted to the detector 750.

The terahertz reflection imaging system illustrated in FIG. 7 may use the rotating parabolic mirror 730 to collimate or condense a terahertz beam without using a collimating lens or multiple number of lenses or a condensing lens, and thus a configuration of the terahertz reflection imaging system may be more simplified or streamlined and the terahertz reflection imaging system may thus be reduced in size.

In addition, by minimizing a number of lenses included in the terahertz reflection imaging system, the terahertz reflection imaging system may minimize a loss that may be caused by a lens.

FIG. 8 is a diagram illustrating further another example of a terahertz reflection imaging system according to an example embodiment.

Referring to FIG. 8, a terahertz reflection imaging system may be specialized for imaging or scanning an inner side of a cylindrical specimen 801. The inner side of the cylindrical specimen 801 may be parabolic, and thus a terahertz beam reflected from a rotating parabolic mirror 830 may be transmitted vertically to the inner side of the cylindrical specimen 801 without a telecentric f-theta lens.

When a light source 810 outputs a terahertz beam having a diverging characteristic, a collimating lens 811 collimates the terahertz beam output from the light source 810 and transmits the collimated terahertz beam to a beam splitter 820.

A terahertz beam transmitted from the beam splitter 820 to the rotating parabolic mirror 830 is condensed while being reflected from the rotating parabolic mirror 830 and is then transmitted vertically to the inner side of the cylindrical specimen 801.

In addition, the terahertz beam incident on the inner side of the cylindrical specimen 801 is reflected from the inner side of the cylindrical specimen 801 and is then transmitted to the rotating parabolic mirror 830. Herein, the terahertz beam incident on the rotating parabolic mirror 830 is spread while being reflected from the rotating parabolic mirror 830 in a direction in which the beam splitter 820 is disposed. In addition, the terahertz beam reflected from the rotating parabolic mirror 830 is reflected from the beam splitter 820 in a direction in which a detector 840 is disposed. Herein, the terahertz beam reflected from the beam splitter 820 is condensed into the detector 840 while passing through a condensing lens 812.

The terahertz reflection imaging system illustrated in FIG. 8 may be optimized for measuring the inside of a cavity having a circular cross section, such as, for example, a pipe and a hole. To measure the inside of pipes or holes having various internal diameters, a focus may need to be on the inner side of the cylindrical specimen 801. Thus, by changing positions of the collimating lens 811 and the condensing lens 812, the terahertz reflection imaging system of FIG. 8 may include a configuration to adjust a focal length of a terahertz, beam to be condensed while being reflected from the rotating parabolic mirror 830.

In addition, polarized light of a terahertz beam reflected from the inner side of the cylindrical specimen 801 may be rotated by a rotation of the rotating parabolic mirror 830, and thus the light source 810 may be a terahertz generator having circular polarization.

According to example embodiments described herein, a terahertz reflection imaging system may allow a terahertz beam to be transmitted in parallel to a rotation axis using a rotating polyhedral mirror which is a rotating mirror in a polyhedral shape and may be reduced in size and modularized into a small size and facilitate optical alignment.

According to example embodiments described herein, a terahertz reflection imaging system may be reduced in size, yet obtain a high-definition image, compared to an existing terahertz imaging system, by reflecting a terahertz beam using a rotating parabolic mirror smaller than a mirror used in the existing terahertz imaging system.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A terahertz, reflection imaging system, comprising:
a light source configured to output a terahertz beam;
a rotating polyhedral mirror of which a mirror is combined with each of polyhedral faces, and configured to reflect a terahertz beam transmitted from the light source in a direction in which a specimen is disposed;
a telecentric f-theta lens configured to transmit the terahertz beam reflected from the rotating polyhedral mirror to the specimen and correct a chief ray of the terahertz beam reflected from the rotating polyhedral mirror to be parallel to an optical axis of the telecentric f-theta lens; and
a detector configured to detect a terahertz beam reflected from the specimen,
wherein the rotating polyhedral mirror is configured to rotate in a preset direction to change a reflection direction of the terahertz beam and change a position of the terahertz beam incident on the specimen.

2. The terahertz reflection imaging system of claim 1, wherein the rotating polyhedral mirror includes a first face configured to reflect the terahertz beam in the direction in which the specimen is disposed, and a second face configured to reflect a terahertz beam reflected from the specimen and passing through the telecentric f-theta lens in a direction in which the detector is disposed,
wherein the telecentric f-theta lens is configured to transmit the terahertz beam reflected from the specimen to the second face.

3. The terahertz reflection imaging system of claim 1, when the light source does not output a collimated terahertz beam, further comprising:
a collimating lens or multiple number of lenses configured to collimate the terahertz beam output from the light source and transmit the collimated terahertz beam to the rotating polyhedral mirror; and
a condensing lens configured to condense the terahertz beam reflected from the specimen and transmit the condensed terahertz beam to the detector.

4. The terahertz reflection imaging system of claim 1, further comprising:
a beam splitter configured to allow the terahertz beam output from the light source to be transmitted, and reflect the terahertz beam reflected from the rotating polyhedral mirror in a direction in which the detector is disposed,
wherein the telecentric f-theta lens is configured to transmit the terahertz beam reflected from the specimen to the rotating polyhedral mirror, and
the rotating polyhedral mirror is configured to reflect the terahertz beam transmitted from the telecentric f-theta lens in a direction in which the beam splitter is disposed.

5. A terahertz reflection imaging system, comprising:
a light source configured to output a terahertz beam;
a rotating mirror configured to reflect a terahertz beam transmitted from the light source in a direction in which a specimen is disposed, using a mirror tilted at a preset angle;
a telecentric f-theta lens configured to transmit the terahertz beam reflected from the rotating mirror to the specimen and correct a chief ray of the terahertz beam reflected from the rotating mirror to be parallel to an optimal axis of the telecentric f-theta lens; and
a detector configured to detect a terahertz beam reflected from the specimen,
wherein the rotating mirror is configured such that the mirror having a rotation axis rotates in a preset direction to change a reflection direction of the terahertz beam and change a position of the terahertz beam incident on the specimen.

6. The terahertz, reflection imaging system of claim 5, when the light source does not output a collimated terahertz beam, further comprising:
a collimating lens or multiple number of lenses configured to collimate the terahertz beam output from the light source and transmit the collimated terahertz beam to the rotating mirror; and
a condensing lens configured to condense the terahertz beam reflected from the specimen and transmit the condensed terahertz beam to the detector.

7. A terahertz reflection imaging system, comprising:
a light source configured to output a terahertz beam;
a rotating parabolic mirror configured to reflect a terahertz beam transmitted from the light source in a direction in which a specimen is disposed, using a parabolic mirror;
a telecentric f-theta lens configured to transmit the terahertz beam reflected from the rotating parabolic mirror to the specimen and correct a chief ray of the terahertz beam reflected from the rotating parabolic mirror to be parallel to an optical axis of the telecentric f-theta lens; and
a detector configured to detect a terahertz beam reflected from the specimen,
wherein the parabolic mirror is configured to collimate the terahertz beam transmitted from the light source and reflect the collimated terahertz beam to the telecentric f-theta lens, and
the rotating parabolic mirror is configured such that the parabolic mirror having a rotation axis rotates in a preset direction to change a reflection direction of the terahertz beam and change a position of the terahertz beam incident on the specimen.
